(19) United States
(12) Patent Application Publication
(10) Pub. No.: US 2007/0221544 A1
(43) Pub. Date: Sep. 27, 2007

(54) Pulp sizing screen

(76) Inventor: Chao-Ho Chen, Taichung Hsien (TW)

Correspondence Address: Paul D. Greeley, Esq.;Ohlandt, Greeley, Ruggiero & Perle, L.L.P., 10th Floor, One Landmark Square, Stamford, CT, 06901-2682, US

(21) Appl. No.: 11/451,242

(22) Filed: Jun. 12, 2006

(30) Foreign Application Priority Data
Mar. 24, 2006 (TW) 095110254

(51) Int. Cl. B07B 1/22; B07B 1/49

(52) U.S. Cl. 209/270; 209/395

(57) ABSTRACT

A pulp sizing screen includes a hollow cylindrical body that defines an axis and an inner space. The cylindrical body includes: a plurality of supporting rings aligned with and spaced apart from each other along the axis, each of the supporting rings being formed with a plurality of angularly displaced notches, each of the notches having a tail section and a head section enlarged in size from the tail section in a radial direction and having a sector shape; and a plurality of slot-defining bars, each of which extends from an endmost one of the supporting rings to the other endmost one of the supporting rings through respective ones of the notches in the supporting rings, and each of which has a middle portion extending through the tail sections of the respective ones of the notches, a first head portion received in the head sections of the respective ones of the notches, and a second head portion disposed in the inner space.

### BACKGROUND OF THE INVENTION

1. Field of the Invention

This invention relates to a pulp sizing screen.

2. Description of the Related Art

FIG. 1 illustrates a conventional pulp sizing screen which includes a plurality of supporting bars 2 and a plurality of supporting rings 1 (only one of which is shown). Each of the supporting rings 1 is formed with a plurality of equi-angularly displaced grooves 101. Each of the supporting bars 2 has a base part 202 formed with a retaining portion 201. After assembly, the retaining portions 201 of the base parts 202 of the supporting bars 2 are tightly held in the grooves 102, and the interval between two adjacent ones of the supporting rings 1 and the interval between two adjacent ones of the supporting bars 2 are fixed, i.e., the mesh size of the screen is fixed. However, when the pulp to be treated contains large particles and large fibers, and when the amount of the pulp to be treated is large, the retaining portions 201 of the base parts 202 of the supporting bars 2 tend to be drawn out of the grooves 101 by the pulp, which results in undesired change in the mesh size of the screen.

FIG. 2 shows another conventional pulp sizing screen including a plurality of supporting bars 4 and a plurality of supporting rings 3 (only one of which is shown). Each of the supporting rings 3 is formed with a plurality of grooves 301 each of which is constituted by a circular portion 302 and a passage portion 303. Each of the supporting bars 4 includes a head portion 401 fittingly engaging with the circular portion 302 of the respective one of the grooves 301 of the supporting rings 3, an intermediate portion 402 extending from the head portion 401 through the passage portion 303 of the respective one of the grooves 301 of the supporting rings 3, and an outer potion 403 extending from the intermediate portion 402 beyond the supporting rings 3. The intermediate portion 402 includes an inner end 402A. The head portion 401 is enlarged in size from the inner end 402A of the intermediate portion 402 so as to avoid the aforementioned problem encountered in the above conventional pulp sizing screen shown in FIG. 1. However, since the head portion 401 is circular in shape, and since a clearance exists between the intermediate portion 402 of the supporting bars 4 and the wall defining the passage portion 303 of the groove 301 to facilitate assembly, the supporting bars 4 tend to undesirably rotate when the pulp sizing screen is operated, which, in turn, results in variation of the mesh size of the pulp sizing screen.

### SUMMARY OF THE INVENTION

Therefore, the object of the present invention is to provide a pulp sizing screen that can overcome the aforesaid drawbacks of the prior art.

According to this invention, a pulp sizing screen comprises: a hollow cylindrical body that defines an axis and an inner space. The cylindrical body includes a plurality of supporting rings aligned with and spaced apart from each other along the axis. Each of the supporting rings includes an inner surface and an outer surface, and is formed with a plurality of angularly displaced notches indented inwardly from the inner surface. Each of the notches has a tail section and a head section enlarged in size and extending from the tail section in a radial direction toward the outer surface and having a sector shape. The cylindrical body further includes a plurality of slot-defining bars. Each of the slot-defining bars extends from an endmost one of the supporting rings to the other endmost one of the supporting rings through respective ones of the notches in the supporting rings. Each of the slot-defining bars has a middle portion extending fittingly through the tail sections of the respective ones of the notches in the supporting rings and having an inner end and an outer end, a first head portion enlarged in size from the outer end of the middle portion and received fittingly in the head sections of the respective ones of the notches in the supporting rings, and a second head portion enlarged in size from the inner end of the middle portion and disposed in the inner space.

### BRIEF DESCRIPTION OF THE DRAWINGS

Other features and advantages of the present invention will become apparent in the following detailed description of the preferred embodiments of this invention, with reference to the accompanying drawings, in which:

FIG. 1 is a fragmentary schematic view of a conventional pulp sizing screen;

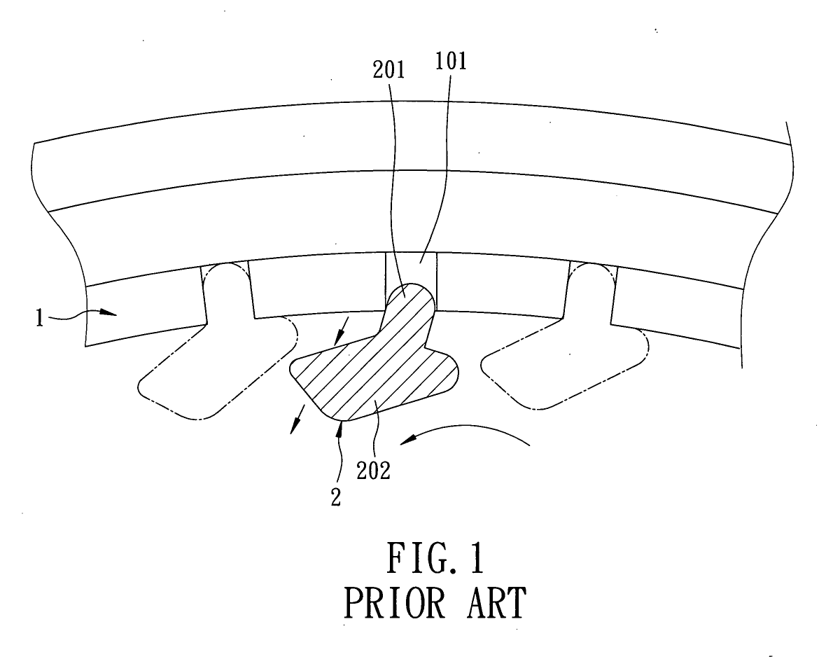

FIG. 2 is a fragmentary schematic view of another conventional pulp sizing screen;

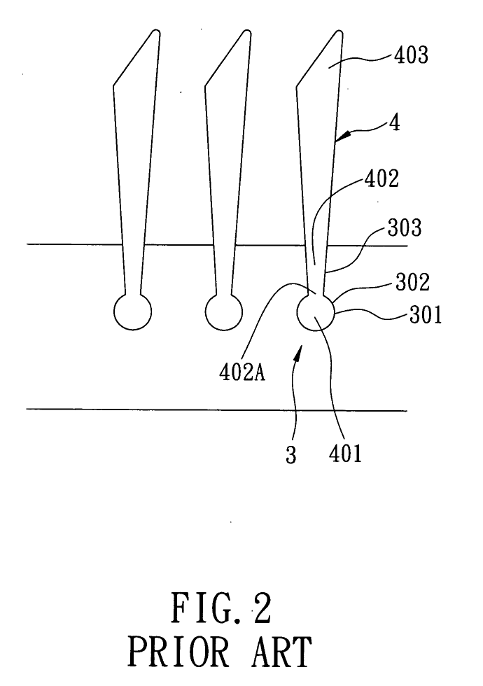

FIG. 3 is a top view of the first preferred embodiment of a pulp sizing screen according to this invention;

FIG. 4 is an exploded perspective view to illustrate how the slot-defining bars extend through notches in the supporting rings of the first preferred embodiment;

FIG. 5 is a partly cross-sectional view illustrating the relationship between a supporting ring and a slot-defining bar of the first preferred embodiment;

FIG. 6 is an assembled perspective view of the first preferred embodiment; and

FIG. 7 is a schematic view of the second preferred embodiment of a pulp sizing screen according to this invention.

### DETAILED DESCRIPTION OF THE PREFERRED EMBODIMENTS

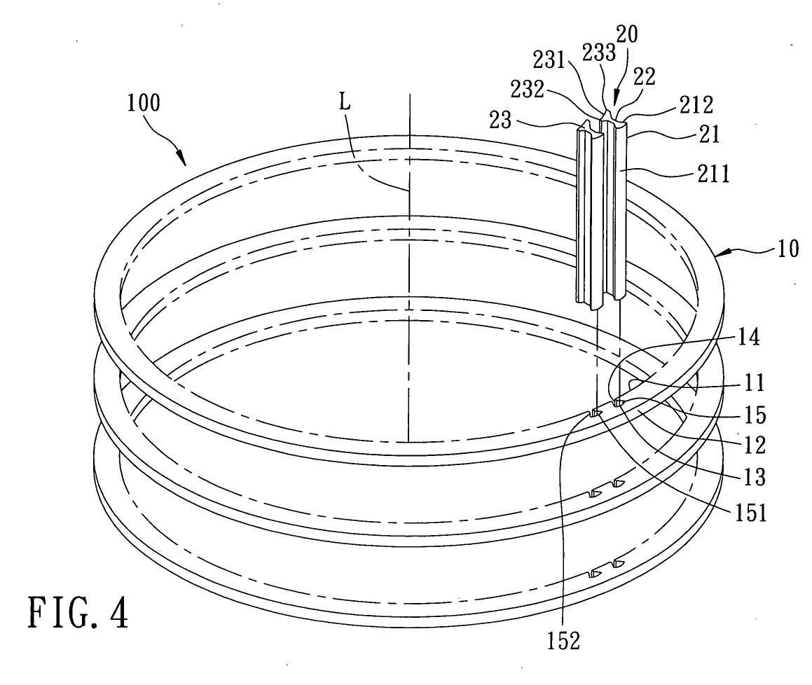

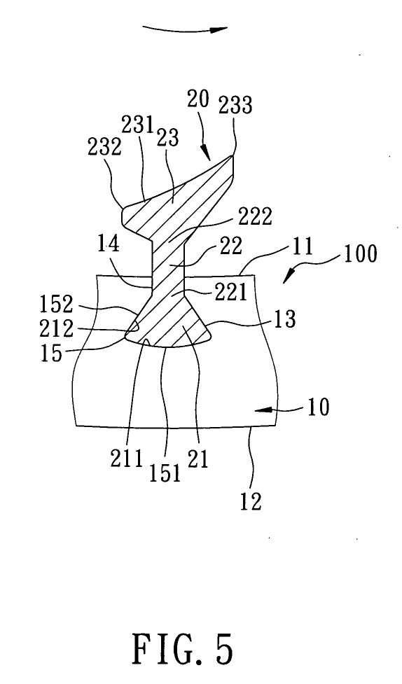

Referring to FIGS. 4 and 5, the first preferred embodiment of a pulp sizing screen 100 according to the present invention is shown to include a hollow cylindrical body that defines an axis (L) and an inner space. The cylindrical body includes a plurality of supporting rings 10 aligned with and spaced apart from each other along the axis (L). Each of the supporting rings 10 includes an inner surface 11 and an outer surface 12, and is formed with a plurality of angularly displaced notches 13 indented inwardly from the inner surface 11. Each of the notches 13 has a tail section 14 and a head section 15 enlarged in size and extending from the tail section 14 in a radial direction toward the outer surface 12 and having a sector shape.

The cylindrical body further includes a plurality of slot-defining bars 20. Each of the slot-defining bars 20 extends from an endmost one of the supporting rings 10 to the other endmost one of the supporting rings 10 through respective ones of the notches 13 in the supporting rings 10. Each of the slot-defining bars 20 has a middle portion 22 extending fittingly through the tail sections 14 of the respective ones of the notches 13 in the supporting rings 10 and having an outer end 221 and an inner end 222 (see FIG. 5), a first head portion 21 enlarged in size from the outer end 221 of the middle portion 22 and received fittingly in the head sections 15 of the respective ones of the notches 13 in the supporting rings 10, and a second head portion 23 enlarged in size from the inner end 222 of the middle portion 22 and disposed in the inner space.

Preferably, as shown in FIG. 5, the head section 15 having a sector shape is confined by a bottom wall 151 and a peripheral wall 152. The first head portion 21 has an end wall 211 and a peripheral wall 212. The end wall 211 and the peripheral wall 212 of the first head portion 21 conform to the bottom wall 151 and the peripheral wall 152 of the head section 15, respectively. With this structure, undesired movement of the slot-defining bars 20 relative to the supporting rings 10 during screening can be prevented.

Preferably, each of the second head portions 23 has an end face 231 that includes a first edge 232 proximate to the inner surface 11 and a second edge 233 remote from the inner surface 11, and that is inclined from the first edge 232 to the second edge 233 with respect to the inner surface 11.

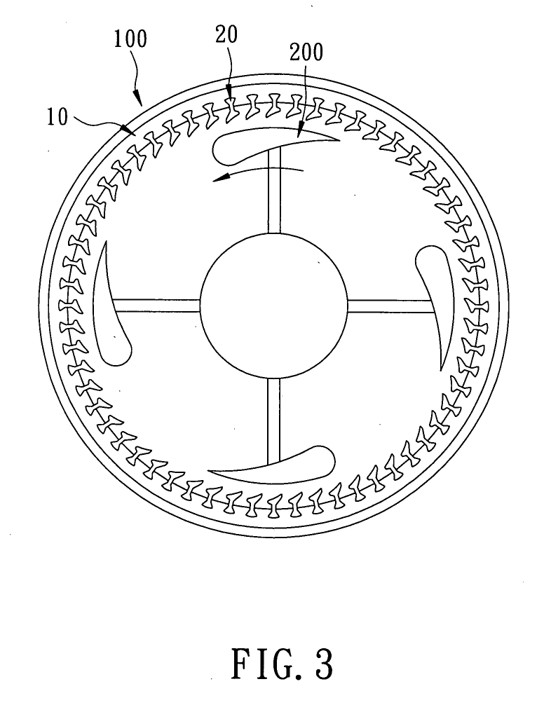

Referring to FIG. 3, in combination with FIG. 5, the pulp sizing screen 100 of this invention is provided with a mixer 200 to accomplish the pulp screening process. It should be noted herein that the mixer 200 rotates counterclockwise in accordance with the direction from the first edge 232 of each of the slot-defining bars 20 to the second edge 233 of each of the slot-defining bars 20.

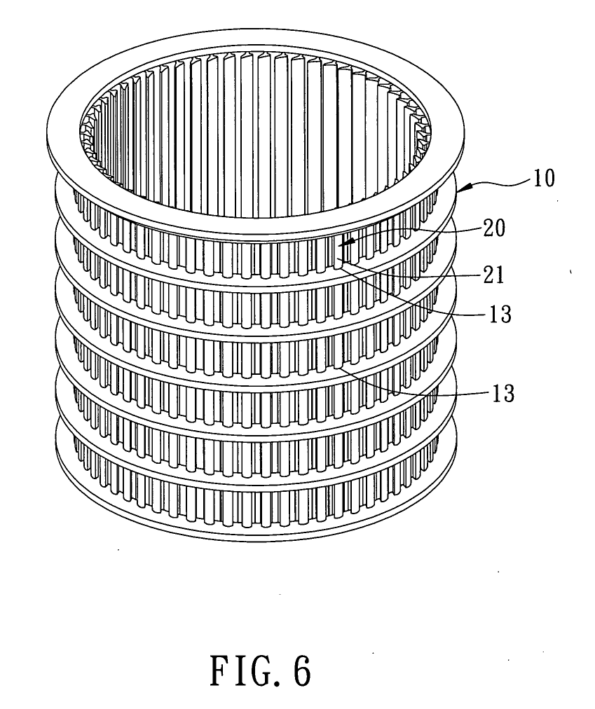

As shown in FIG. 6, in this embodiment, each of the slot-defining bars 20 extends in a direction parallel to the axis (L).

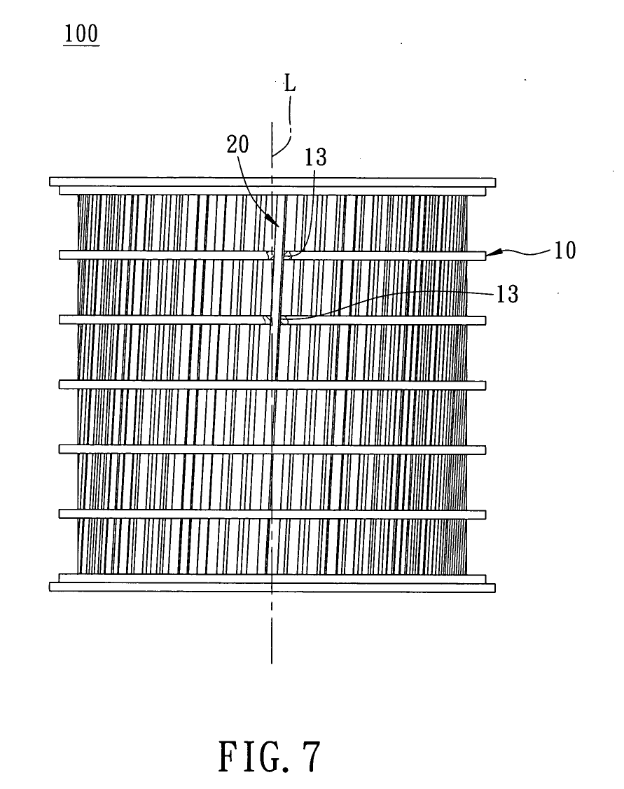

FIG. 7 illustrates the second preferred embodiment of this invention which differs from the previous embodiment in that each of the slot-defining bars 20 extends in a direction oblique to a plane that radiates from the axis (L). During assembly, the notches 13 in each of the supporting rings 10 are respectively aligned with the notches 13 in an adjacent one of the supporting rings 10, followed by insertion of the slot-defining bars 20 into the notches 13 in the supporting rings 10 and relative rotation among the supporting rings 10 so as to obtain the pulp sizing screen 100 shown in FIG. 7.

With the structure of the slot-defining bars 20 and the structure of the notches 13 in the supporting rings 10, the aforesaid drawbacks associated with the prior art can be avoided.

While the present invention has been described in connection with what is considered the most practical and preferred embodiments, it is understood that this invention is not limited to the disclosed embodiments but is intended to cover various arrangements included within the spirit and scope of the broadest interpretation and equivalent arrangements.

What is claimed is:

1. A pulp sizing screen comprising:
a hollow cylindrical body that defines an axis and an inner space, said cylindrical body including:
a plurality of supporting rings aligned with and spaced apart from each other along said axis, each of said supporting rings including an inner surface and an outer surface, and being formed with a plurality of angularly displaced notches indented inwardly from said inner surface, each of said notches having a tail section and a head section enlarged in size and extending from said tail section in a radial direction toward said outer surface and having a sector shape; and
a plurality of slot-defining bars, each of which extends from an endmost one of said supporting rings to the other endmost one of said supporting rings through respective ones of said notches in said supporting rings, and each of which has a middle portion extending fittingly through said tail sections of the respective ones of said notches in said supporting rings and having an inner end and an outer end, a first head portion enlarged in size from said outer end of said middle portion and received fittingly in said head sections of the respective ones of said notches in said supporting rings, and a second head portion enlarged in size from said inner end of said middle portion and disposed in said inner space.

2. The pulp sizing screen of claim 1, wherein each of said slot-defining bars extends in a direction parallel to said axis.

3. The pulp sizing screen of claim 1, wherein each of said slot-defining bars extends in a direction oblique to a plane that radiates from said axis.
